(19) United States
(12) Patent Application Publication
(10) Pub. No.: US 2007/0122773 A1
(43) Pub. Date: May 31, 2007

(54) Activity system for drawing and viewing 3-dimensional images

(76) Inventor: Martin Patrick Du Bois, Allentown, PA (US)

Correspondence Address: Martin Patrick Du Bois, 2558 West Rock Road, Allentown, PA, 18103, US

(21) Appl. No.: 11/271,338

(22) Filed: Nov. 12, 2005

(51) Int. Cl. G09B 11/00

(52) U.S. Cl. 434/85

(57) ABSTRACT

An activity system is for drawing and/or writing on a fixed medium and includes a drawing device manually operable by a user. The drawing device forms first graphic lines of a first color on the medium and second graphic lines of a second color on the medium such that the second line is spaced apart from and extends generally parallel with the first line. A viewer is preferably wearable on a user's head and includes a first transparent portion of the first color and a second transparent portion of the second color, the first and second lines formed by the drawing device being viewable by through the two transparent portions. The first transparent portion filters light of the first color and the second transparent portion filters light of the second color, such that the user experiences a mental impression that the first and second line are disposed in separate, spaced apart planes.

The present invention relates to graphical systems, and more specifically to a system for forming and viewing three-dimensional images.

Three-dimensional or “3-D” movies and images are known and have been enjoyed by many since the 1950s. However, it is believed that there has been no device or kit for making and enjoying such images available to an average user or consumer.

### SUMMARY OF THE INVENTION

In one aspect, the present invention is an activity system for drawing and/or writing on a fixed medium. The system comprises a drawing device manually operable by a user and configured to form a first graphic line of a first color on the medium and a second graphic line of a second color on the medium, such that the second line is spaced apart from and extends generally parallel with the first line. A viewer has a first generally transparent portion of the first color and a second generally transparent portion of the second color. The viewer is positionable generally adjacent to the user's face such that the first and second lines formed by the drawing device are viewable by the user through the two generally transparent portions.

In another aspect, the present invention is an activity kit comprising a medium including at least one material sheet with a first set of spaced-apart marks and a second set of spaced-apart marks. Each mark of the second set is located generally proximal to and spaced apart from a separate one of the marks of the first set by a predetermined distance. The kit may include a drawing device configured to form a first graphic line of a first color on the medium and a second graphic line of a second color on the medium. Alternatively, the kit may include a first drawing implement configured to form lines of the first color and a second drawing implement configured to form lines of the second color.

In a further aspect, the present invention is an activity kit for drawing images on a fixed medium. The kit comprises either a drawing device as described above or at least two, first and second drawing implements, as is also described above. The kit also includes a viewer having a first generally transparent portion of the first color and a second generally transparent portion of the second color. The viewer is configured to be worn on the user's head such that first and second lines formed by the drawing implement are viewable through each one of the two generally transparent portions.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a perspective view of an activity system of the present invention, showing a drawing device forming two lines and being viewed by a user wearing a viewer;

FIG. 2 is front plan view of one construction of a drawing device;

FIG. 3 is a cross-sectional view of the drawing device of FIG. 2;

FIG. 4 is a front plan of another construction of the drawing device including two clip holder devices and shown with additional drawing implements;

FIGS. 5A and 5B, collectively FIG. 5, are each a front plan view of a separate, exemplary construction of the clip holder of the drawing device of FIG. 4;

FIGS. 6A and 6B, collectively FIG. 6, are each a top plan view of a separate one of the two alternative exemplary holders of FIG. 5;

FIG. 7 is a front elevational view of a further construction of the drawing device including a sleeve holder device;

FIG. 8 is a top view of the sleeve holder device of FIG. 7;

FIG. 9 is a longitudinal cross-sectional view of the sleeve holder device of FIG. 7, showing an exemplary retainer;

FIGS. 10A and 10B, collectively FIG. 10, are each a separate radial cross-sectional view through line 10-10 of FIG. 9, showing retention and release positions of the retainer device;

FIG. 11 is a side perspective view of yet anther construction of the drawing device including two finger drawing implements, shown on two of the user's fingers;

FIG. 12 is a cross-sectional view of one finger drawing implement of FIG. 11;

FIG. 13 is a front plan view of one construction of the viewer;

FIG. 14 is a side perspective view of the viewer of FIG. 13;

FIG. 15 is a front plan view of another construction of the viewer;

FIG. 16 is a front plan view of the viewer of FIG. 15, shown with a pane removed and another pane being installed;

FIG. 17 is a top plan view of the viewer of FIG. 15;

FIG. 18 is a front perspective view of an exemplary media of a second embodiment of the present invention;

FIG. 19 is a front perspective view of a set of first lines being formed on the media of FIG. 18;

FIG. 20 is a front perspective view of a set of second lines being formed on the media of FIG. 18; and

FIG. 21 is a front perspective view of a finished image formed on the media of FIG. 18, shown being observed by a user.

### DETAILED DESCRIPTION OF THE INVENTION

Certain terminology is used in the following description for convenience only and is not limiting. The words “right”, left”, “lower”, “upper”, “upward”, “down” and “downward” designate directions in the drawings to which reference is made. The words “inner” and “outer” refer to directions toward and away from, respectively, a designated centerline or a geometric center of an element being described, the particular meaning being readily apparent from the context of the description. Further, as used herein, the word “connected” is intended to include direct connections between two members without any other members interposed therebetween and indirect connections between members in which one or more other members are interposed therebetween. The terminology includes the words specifically mentioned above, derivatives thereof, and words of similar import.

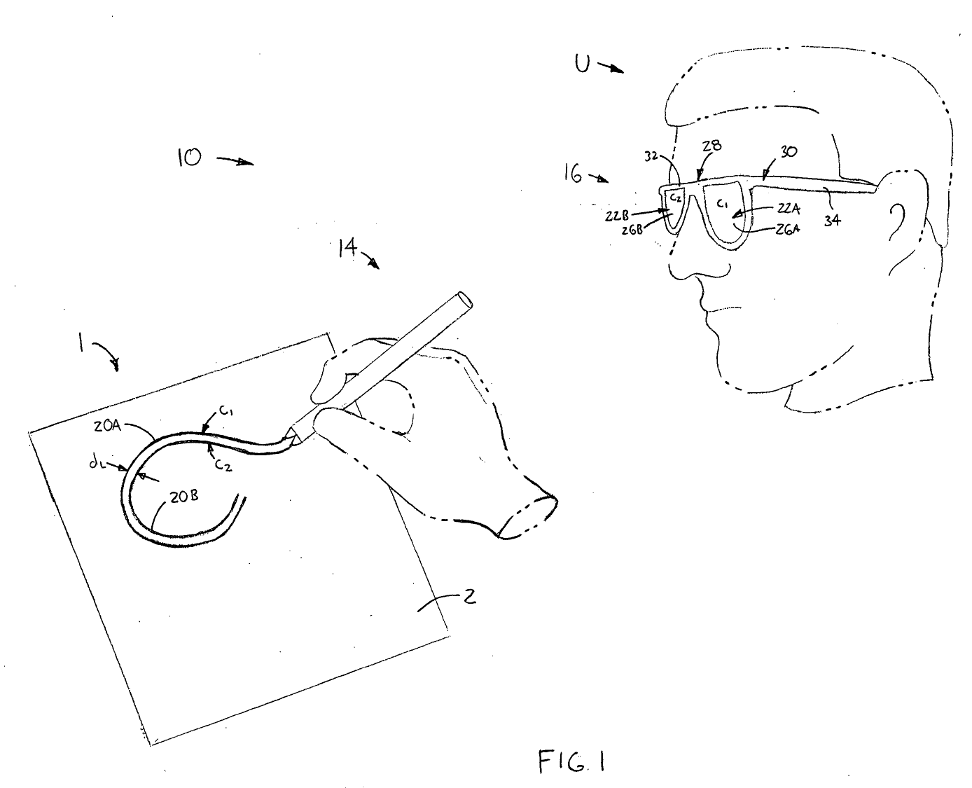

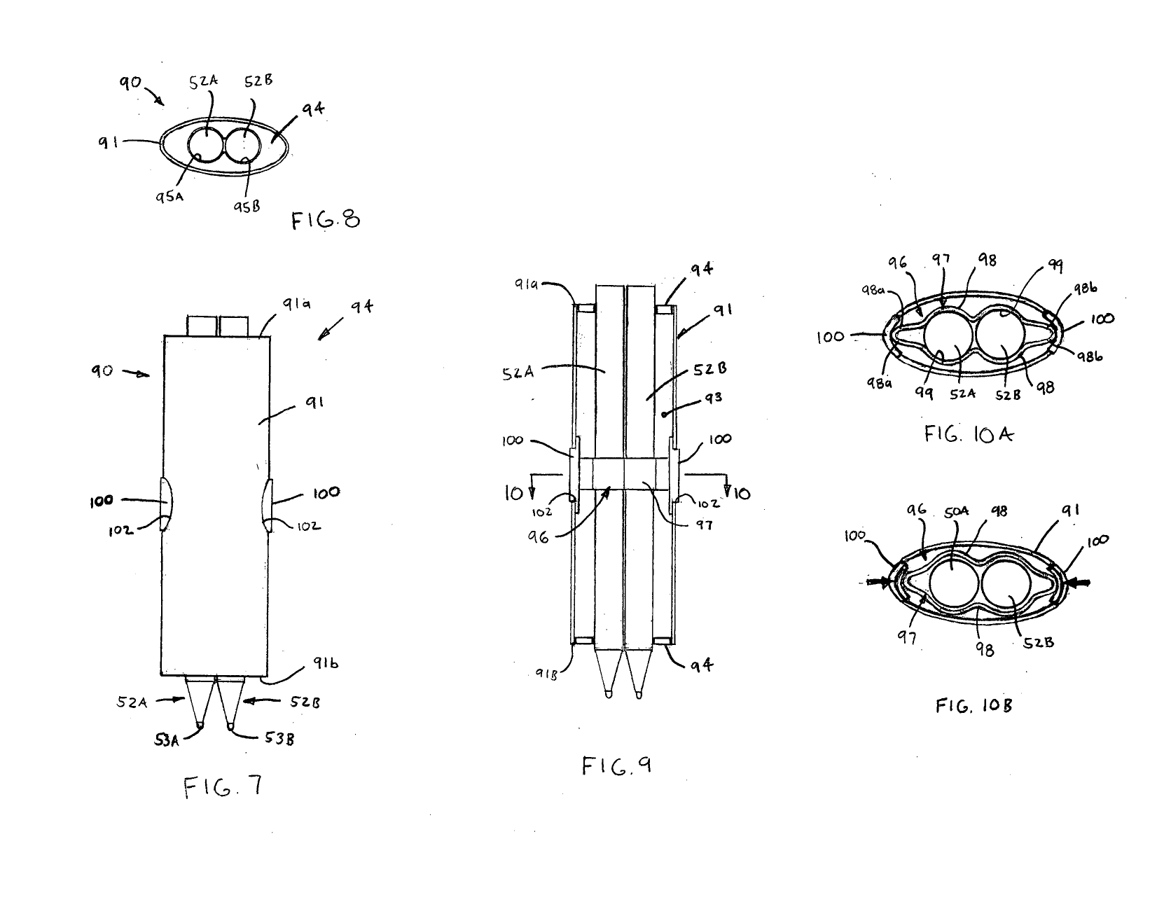

Referring now to the drawings in detail, wherein like numbers are used to indicate like elements throughout, there is shown in FIGS. 1-17 an activity system 10 for drawing and/or writing on a fixed medium 1, in accordance with a first embodiment of the present invention. The medium 1 may include a single sheet of material 2 (e.g., paper), a booklet including a plurality of material sheets 2, a drawing board or an erasable board (neither shown), or any other medium capable of accepting a fixed graphic line or image, as opposed to an electronic or other temporary graphic image/line (e.g., computer graphics). The activity system 10 basically comprises at least one drawing device 14 and a viewer 16, and may additionally include medium 1 as part of the kit 12. The drawing device 14 is manually operable by a user U and is configured to form a first graphic line 20A of a first color C₁ (e.g., red) on the medium 1 and a second graphic line 20B of a second color C₂ (e.g., blue) on the medium 1. The drawing device 14 is configured such that the second line 20B is spaced apart from and extends generally parallel with the first line 20A, such that the two lines 20A, 20B are spaced apart by a substantially constant distance d_{L}, and is preferably configured to simultaneously form the first and second lines 20A, 20B, as described below. Additionally, the drawing device 14 may be selectively configurable to form at least one third graphic line 20C of a third color C₃ (e.g., green) on the medium 1 (or a fourth, fifth, sixth line, etc.) such that the third line 20C is spaced apart from and extends generally parallel with either one first line 20A or one second line 20B. Further, the drawing device 14 is preferably configured to be manually grasped by the user U, but may alternatively be constructed so as to be attachable to one of the user's hands (FIGS. 7 and 8), specifically one or more fingers, as discussed below.

Furthermore, the viewer 16 has a first generally transparent portion 22A of the first color C₁ and a second generally transparent portion 22B of the second color C₂. The viewer 16 is positionable generally adjacent to the user's face such that the first and second lines 20A, 20B formed by the drawing device 14 are viewable by the user through the two generally transparent portions 22A, 22B. Preferably, the viewer 16 is configured to be worn on the user's head such that the first transparent portion 22A is disposed forwardly of one of the user's eyes (e.g., left eye) and the second transparent portion 22B is disposed forwardly of the other one of the user's eyes (i.e., right eye). However, the viewer 16 may be alternatively formed as a handheld device which a user places forwardly or the user's eyes or a stationary device against which a user positions the user's face (neither alternative depicted).

In any case, the viewer first transparent portion 22A is configured to filter light of the first color C₁ and the second transparent portion 22B is configured to filter light of the second color C₂. As such, the viewer 16 is configured to create in the user U a mental impression that the first line 20A is disposed in a first plane and the second line 20B is disposed in a second plane, the second plane being spaced apart from the first plane. In other words, when the user U views the first and second lines 20A, 20B through the viewer device 16, at least one of the two lines 20A, 20B appears closer to the user than the other line 20B, 20A, and/or appears to be spaced above the medium 1. This phenomena occurs because each eye (e.g., the left eye) only sees one of the two lines (i.e., 20B) since the transparent portion (i.e., 22A) disposed forwardly of that particular eye blocks the image of the other line (i.e., 20A), which is of the same color as the transparent portion. With both transparent portion 22A, 22B only allowing the adjacent eye to “see” a different one of the two lines 20B, 20A, respectively, the two lines 20A, 20B appear to float or to be “lifted” off of the medium 1.

Preferably, each one of the first and second transparent portions 22A, 22B includes a generally transparent pane 26A, 26B, respectively, each pane 26A, 26B being formed of a material of the first and second colors C₁, C₂, respectively. Also, each of the first and second panes 26A, 26B is either attached to a remainder of the viewer 16, as depicted, or may be integrally formed with the remainder of the viewer 16 (not depicted). Preferably, the viewer 16 further includes a frame 28 with two view apertures 29. The frame 28 is mountable to the user's head and configured to retain the first and second panes 26A, 26B such that each pane 26A, 26B is disposed within and/or extends across one view aperture 29. As such, when the frame 28 is mounted to the user's head, the first pane 26A is positioned generally forwardly of one of the user's eyes and the second pane 26B is positioned generally forwardly of the other one of the user' eyes. Further, each pane 26A, 26B may be formed as or provided by a film, a panel, a lens, etc., and the frame 28 is preferably generally similar to an “eyeglass” frame 30. Specifically, the eyeglass frame 30 includes a main frame portion 32 and two side members or arms 34. The main frame portion 32 is configured to retain the preferred first and second panes 26A, 26B and has a central “nose” support section 33 disposeable upon the bridge of the user's nose. Each frame arm 34 has a first end 34a connected with the main frame portion 32 and a second end 34b configured to “hook” about one of the user's ears. Specific details of exemplary viewer constructions are described below.

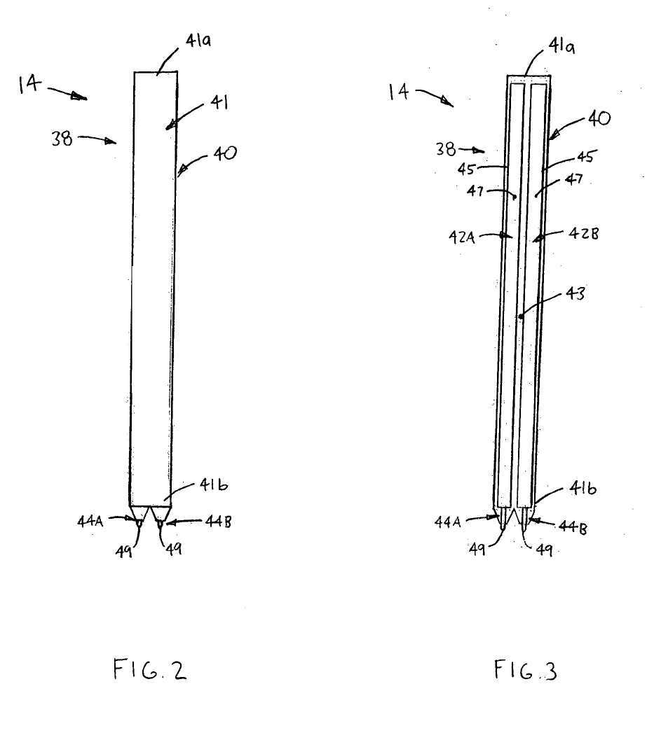

Referring to FIGS. 2 and 3, in certain constructions, the drawing device 14 is an “integrated” drawing device 38 that includes a housing 40, first and second fluid or “ink” reservoirs 42A, 42B, and first and second applicator tips 44A, 44B. The housing 40 preferably includes a generally tubular body 41 of appropriate cross-sectional shape (e.g., rectangular, ovular, etc.) and having upper and lower ends 41a, 4ab, respectively and an interior cavity 43. The first and second fluid/ink reservoirs 42A, 42B are disposed within the housing interior cavity 43 in a “side-by-side” relationship and each includes a generally elongated tubular body 51 with an interior fluid chamber 47. Further, the first fluid reservoir 42A contains a quantity of fluid, preferably a commercially available ink 48A, of the first color C₁ and the second reservoir 42B contains a quantity of fluid/ink 48B of the second color C₂. Furthermore, each of the first and second applicator tips 44A, 44B extends outwardly from the housing lower end 41b and is fluidly connected with an associated one of the first and second reservoirs 42A, 42B, respectively, such that each connected reservoir 42A, 42B and tip 44A, 44B forms a pen unit 51A, 51B, respectively.

The first applicator tip 44A is configured to dispense the first ink 48A so as to form at least one first line 20A, and the second tip 44B is configured to dispense the second ink 48B so as to form at least one second line 20B. The second tip 44B is spaced from the first tip 44B, and the two tips 44A, 44B are preferably simultaneously disposeable upon the medium 1, such that the two lines 20A, 20B are simultaneously formable upon the medium 1. Furthermore, each tip 44A, 44B may include a pressure valve (not depicted) permitting the ink 48A, 48B to flow out the tip ends 49 when pushed against the medium, generally in the manner of a ball point pen, the tips 44A, 44B may be formed as a saturateable felt tip (not depicted) in the manner of a magic marker or highlighter, or may have any other appropriate mechanism for controlling the release of ink or other colored fluid from the associated reservoir 42A, 42B.

Additionally, the integrated drawing device 38 may be constructed with one or more additional pen units (none shown), the drawing device 38 being configured to selectively position two pen units 51N onto the medium 1. For example, the integrated drawing device 38 may be constructed similarly to a commercially available “multicolor pen” including three or more pen units 51N selectively advanceable to extend partially out of the housing 40 (structure not shown). However, unlike a commercial multicolor pen, the drawing device 38 is configured to lock two pen units 51N (e.g., 51A, 51C) into a position such that two spaced apart applicator tips 44N are simultaneously disposeable upon the medium 1, while the one or more other tips 44N are retracted within the housing 40.

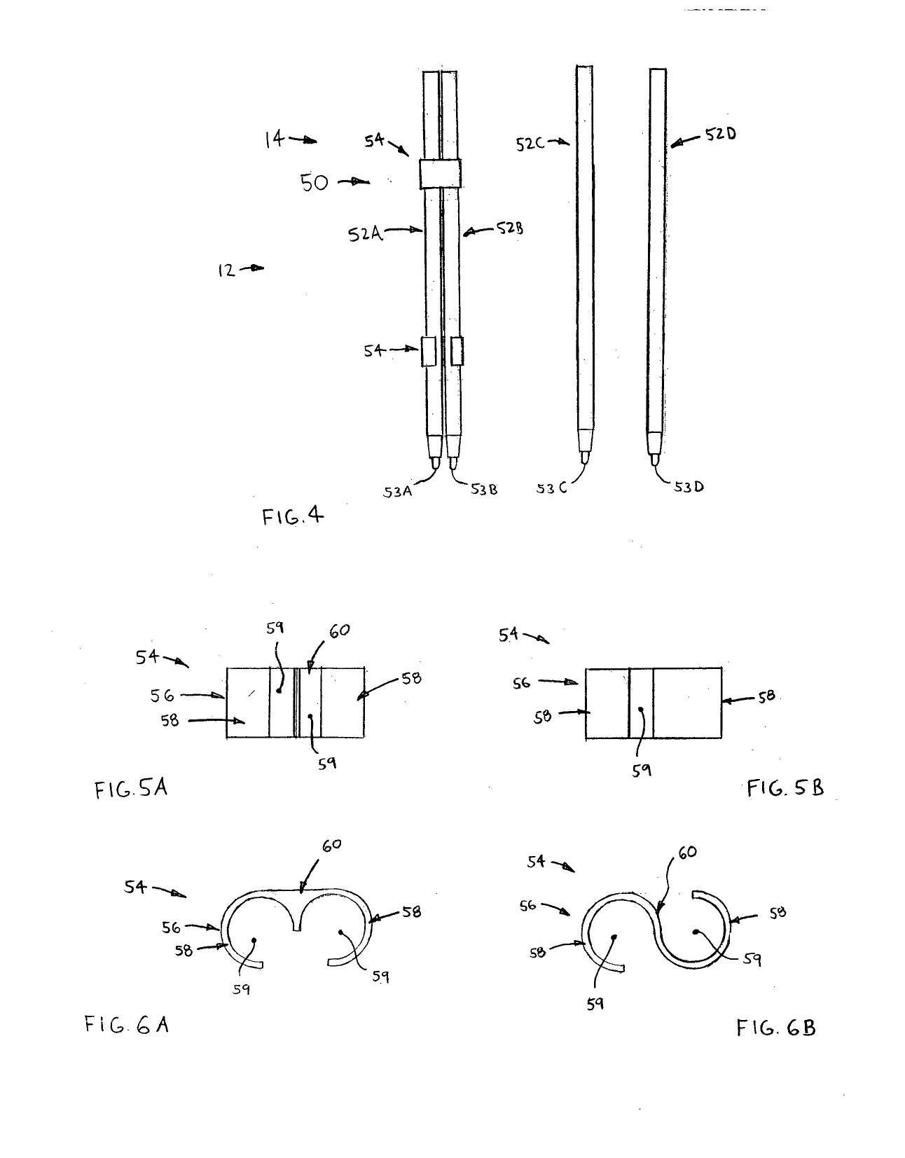

In other constructions as depicted in FIGS. 4-6, the drawing device 14 may be constructed as a “modular” drawing device 50 so as to include separate first and second drawing implements 52A, 52B and a holder 54 configured to receive each of two drawing implements 52A, 52B. Each of the first and second drawing implements 52A, 52B is preferably a conventional drawing implement, such as a pen, a magic marker, a pencil, a highlighter, or other similar device, and each has an applicator tip 53 as appropriate for the type of device (e.g., ball point tip, saturated felt tip, pencil lead end, etc.). The first drawing implement 52A is configured to form at least one and preferably a plurality of first lines 20A and the second drawing implement 52B is configured to form one or more second lines 20B. Further, the holder 54 is configured to connect the two implements 52A, 52B such that the tip 53A, 53B of each one of the implements 52A, 52B, respectively, is spaced apart from and located generally adjacent to the tip 53B, 53A of the other one of the two implements 52B, 52A. As such, when the tips 53A, 53B are placed upon the medium 1 and pulled or “drawn” thereacross, the drawing device 14 simultaneously forms the first and second spaced apart lines 20A, 20B.

The holder 54 may be constructed in any appropriate manner that is capable of receiving and connecting together two drawing implements 52A, 52B as discussed above. Preferably, the holder 54 is configured to removably connect the two drawing implements 52A, 52B; as such, the activity system 10 may be provided as a kit 12 that further includes a third drawing implement 52C, a fourth drawing implement 52D, and/or any additional number of implements 52N. Specifically, the kit 12 may include a third drawing implement 52C configured to form at least one line of a third color C₃ and having an applicator tip 53C, a fourth drawing implement 52C configured to form at least one line of a fourth color C₄ and having an applicator tip 53D, etc. The holder 54 is configured to receive the third and/or fourth drawing implements 52C, 52D when one (or both) of the first and second implements 52A, 52B is separate from the holder 54. The holder 54 thereby connects the third implement 52C (and/or fourth implement 52D) with one of the first and second implements 52A, 52B (or/and fourth or third implements 52D, 52C). As such, the third applicator tip 53C or fourth applicator tips is spaced apart from and located generally adjacent to the applicator tip 53A, 53B (or 53D, 53C) of the connected one of the other implements 52A, 52B, 52C or 52D. As such, either or both of the first and second lines 20A, 20B may be formed of the third color C₃ or the fourth color C₄, particularly when the kit 12 includes removable and interchangeable transparent portions 20 or panes, as described below.

Still referring to FIGS. 5 and 6, in one exemplary construction, the holder 54 is formed as one or more clip devices 56 each having two C-clip portions 58 configured to releasably attach to a separate one of the drawing implements 52N and a central base portion 58 integrally connecting the two clip portions 58. Specifically, each C-clip portion 58 defines a cavity 57 sized to receive a portion of one drawing implement 52N, and is bendable with respect to the base portion 60 to permit an implement 52N to be installed within and removed from the clip cavity 59. In other words, the each C-clip portion 58 has an inner diameter sized slightly lesser than the outside diameter of the particular model or type of drawing implements 52N for which the clip 54 is constructed, such that each clip portions 58 frictionally engages with the outer surface of one drawing implement 52N. In a first construction shown in FIGS. 5A and 6A, each C-Clip portion 58 extends from the same side of the base portion 60; alternatively, in the second construction depicted in FIGS. 5B and 6B, the C-Clip portions 58 extend from opposing sides of the base portion 60, which is much thinner and includes less material than the first construction base 60. Further, the clip device 56 may be constructed to engage one or specific sizes of commercially available drawing implements, or may be formed to be used with specially manufactured implements provided in a kit 12. Furthermore, with the exemplary clip holder 56, it is preferred to use at least two clip holders 56 spaced apart on the two drawing implements 52N to prevent twisting or other relative movement of the implements 52N, although one clip holder 56 is adequate to secure together two implements 52A, 52B, 52C, or/and 52D, etc.

Referring now to FIGS. 7-10, in another exemplary construction, the holder 54 is formed as a sleeve device 90 that includes a tubular body 91 with opposing upper and lower ends 91 a, 91b and configured to receive two drawing implements 52N such that the applicator tips 53N extend from the body lower end 90b. The holder body 91 preferably has a generally ovular cross-sectional shape, as best shown in FIGS. 8 and 10, and defines a central cavity 93 for receiving at least a portion of two drawing implements 52N. Preferably, the sleeve holder 90 further comprises a least one and preferably two guide plates 94 disposed within the body cavity 91, each plate 94 having openings 95A, 95B sized to receive a portion of one drawing implement 52N, and a retainer 96 configured to releasably retain the two drawing implements 52N within the cavity 93. In one exemplary construction, the retainer 96 is a generally elliptical spring device 97, as depicted in FIGS. 9 and 10, although the retainer 96 may be formed in any other appropriate manner. The exemplary retainer spring device 97 includes two retaining arms 98, which define two cavities 99 for receiving the implements 52N, and a pair of button members 100 extending through openings 102 in the holder body 91. The two arms 98 each having opposing ends 98a, 98b connected with the corresponding end 98a, 98b of the other arm 98, preferably integrally formed, the two arms 98 being biased toward each other by material elastic forces to retain the implements 52N with the cavities 99 (see FIG. 10A). Referring to FIG. 10B, when it is desired to remove the drawing implements 52N from the sleeve holder 90, a user pushes the two buttons 100 toward each other, causing the spring device 97 to deflect radially outwardly and move the retainer arms 98 away from each other, thereby permitting the implements 52N to slide free from the sleeve body 91. However, the sleeve holder 90 may include any other device or component for retaining the drawing implements 52N within the tubular sleeve body 91, such as for example, by forming the guide plate(s) 94 to frictionally retain the implements within the plate openings 95A, 95B. Furthermore, the sleeve body may be formed as a generally cylindrical body (not shown) with a pair of longitudinal bores for receiving the two implements 52N, and an appropriate mechanism for releasably retaining the implements therein.

Although two exemplary holders 54 are depicted as a clip device 56 and sleeve device 90, these particular constructions are provided for purposes of illustration of the present invention. Thus, the holder 54 may be constructed in any other appropriate manner capable of releasably or removably securing together two implements 52N such that the tips 53N thereof are spaced apart to form the two parallel lines 20A, 20B, etc. For example, the holder 54 may be constructed as a block or bar with two holes each sized to receive one implement 52N, as one or more elastic bands securable about two implements 52N, etc. The scope of the present invention is not limited to any particular construction of the holder 54 and includes all appropriate constructions capable of permitting the activity system 10 to function generally as described herein.

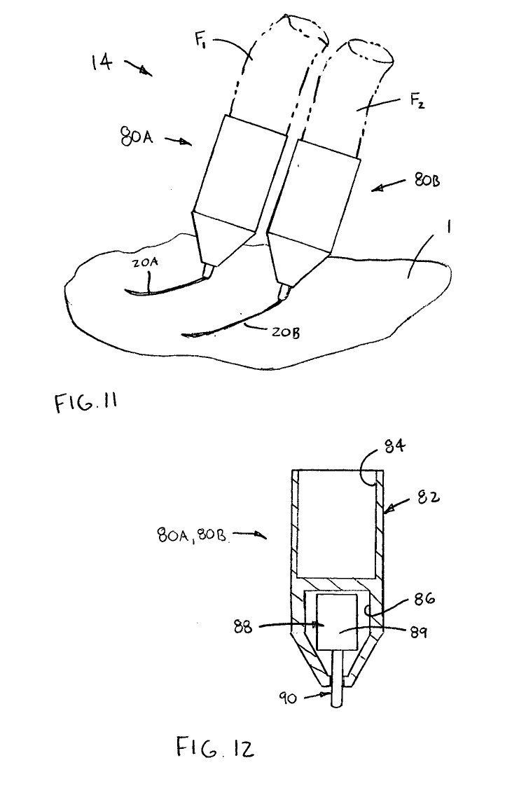

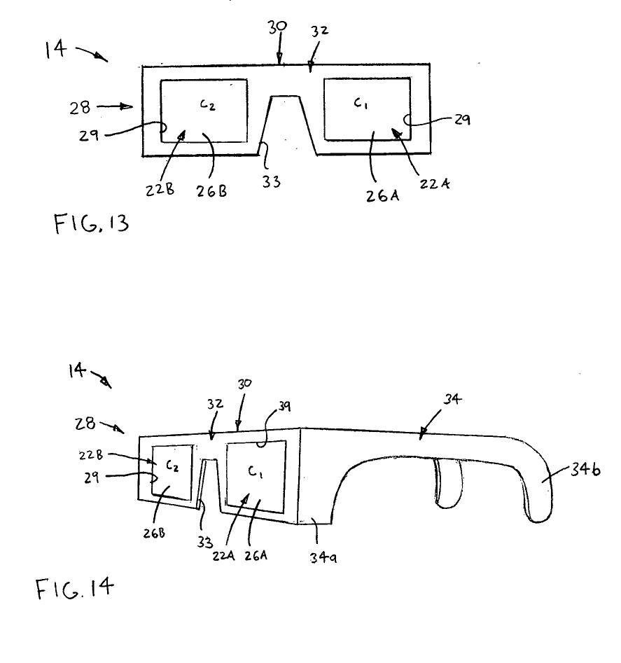

Referring now to FIGS. 11 and 12, the drawing device 14 may alternatively include first and second drawing implements 80A, 80B attachable to the user's fingers. Specifically, a first finger drawing implement 80A is configured to attach to one of a user's fingers F₁ (e.g., the index finger) and to form at least one first line 20A, and the second finger drawing implement 80B is configured to attach to another one of the user's fingers F₂ (e.g., middle finger) and to form at least one second line 20B. The finger drawing implements 80A, 80B may either be completely separate devices (as depicted) or may be connected together or integrally formed (neither shown), so as to facilitate forming lines 20A, 20B that are more truly parallel and uniformly spaced apart. In the exemplary construction of FIGS. 11 and 12, each finger implement 80A, 80B includes a body 82 with an upper cavity 84 sized to receive a user's finger tip and a lower cavity 86, a fluid reservoir 88 containing a quantity of ink 89 or other drawing/marking fluid, and an applicator tip 90 fluidly connected with the reservoir 88. Each finger implement 80A, 80B includes ink 89 of a color C_{N} different than the other implement 80B, 80A, so that the first and second lines 20A, 20B are of different colors C1, C2, etc., as discussed above. It must be noted that the finger drawing implements 80A, 80B as described herein and depicted in FIGS. 7 and 8 are provided as one exemplary construction, and the finger drawing implements 80A, 80B may be of any other appropriate structure that functions as basically described herein.

Referring to FIGS. 13 and 14, in certain constructions, the viewer 16 is formed generally similarly to commonly known “3-D glasses” provided by movie theatres when displaying a “3-D movie”. Specifically, in such a viewer construction, the eyeglass frame 30 may be formed of cardboard, paper, or other disposeable material, and the panes 26A, 26B are preferably formed of a polymeric film (e.g., celluloid) or other similar material and are fixedly attached to the frame 30 by any appropriate means, such as glue, friction, staples, etc. As such, the viewer 16 is relatively low cost to manufacture and lightweight, but may be less durable than other potential designs.

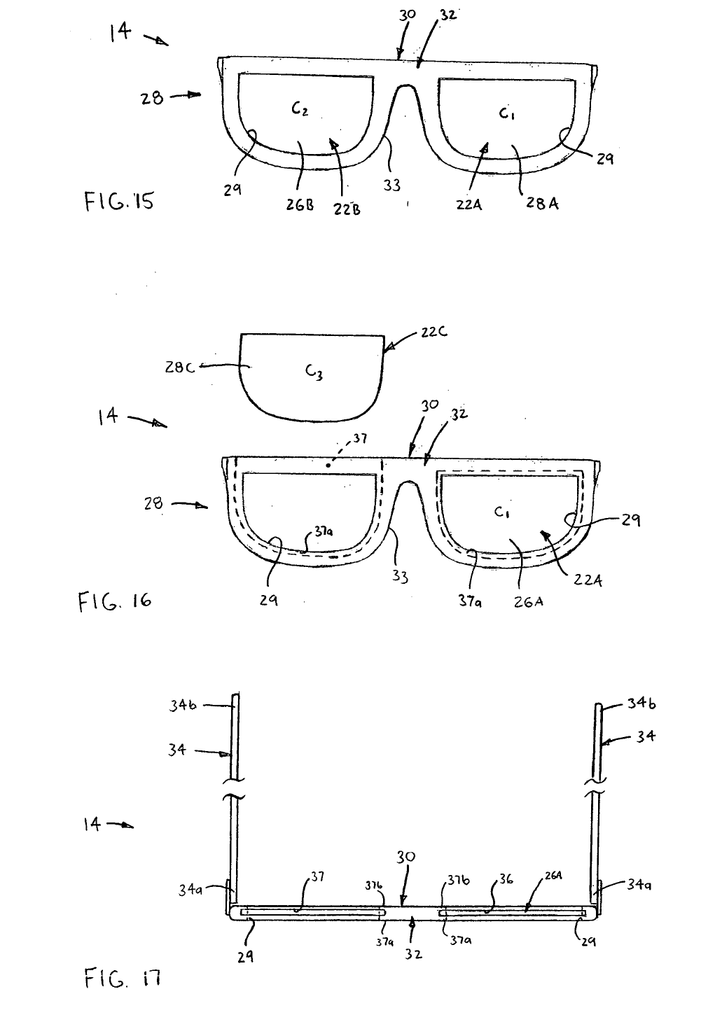

Referring to FIGS. 15-17, in other constructions, the viewer 16 may be formed generally similarly to conventional eyeglasses or sunglasses, except that it is preferred that the panes 26A, 26B have no “focusing” capability. As such, the frame 30 is preferably formed of a generally rigid material, such as a molded polymer or lightweight metal, and the panes 26A, 26B are formed of colored glass, colored plastic or other polymeric material, or any other appropriate material, and are mounted to the frame 30. In certain structures, the panes 26A, 26B may be fixedly attached to the frame 30 by adhesives, threaded fasteners, rivets, frictional retention, or any other appropriate means, such that the panes 26A, 26B are non-removable. Alternatively, as depicted in FIGS. 16 and 17, the frame 30 and panes 26N are constructed such that the panes 26A, 26B are each removably mountable to the frame 30, so as to be readily removable from and installable within the frame 30, and the viewer 16 is preferably provided with one or more additional panes 28C (only one shown).

Specifically, the viewer 16 may further include at least a third generally transparent pane 28C of a third color C₃ (e.g., green) different than the first and second colors C₁, C₂, the third pane 28C being removably mountable to the frame 30 when one of the first and second panes 26A, 26B is separate from the frame 30. The viewer 16 may include any number of additional panes, such as a fourth pane of a fourth color, a fifth pane of a fifth color, etc. (none shown). For example, the main frame portion 32 may be provided with vertically-extending slotted openings 36 each sized to receive one pane 26A, 26B, etc., such that each panel 26N is retained between spaced apart, front and rear edge retaining sections 37a, 37b of the main frame portion 32. Further, such a viewer 16 is preferably used with a drawing device 14 including three or more selectively useable pen units 51N or having or three or more separate implements 52A, 52B, 52C, etc. (see FIG. 4). That is, when a drawing device 14 is capable of producing lines 20A, 20B, 20C, etc. selected from three or more different colors C₁, C₂, C₃, etc., the viewer 16 should be configurable or adjustable such that the color of each transparent portions 22A, 22B corresponds with the specific color of one of the two lines 20A, 20B or/and 20C, etc.

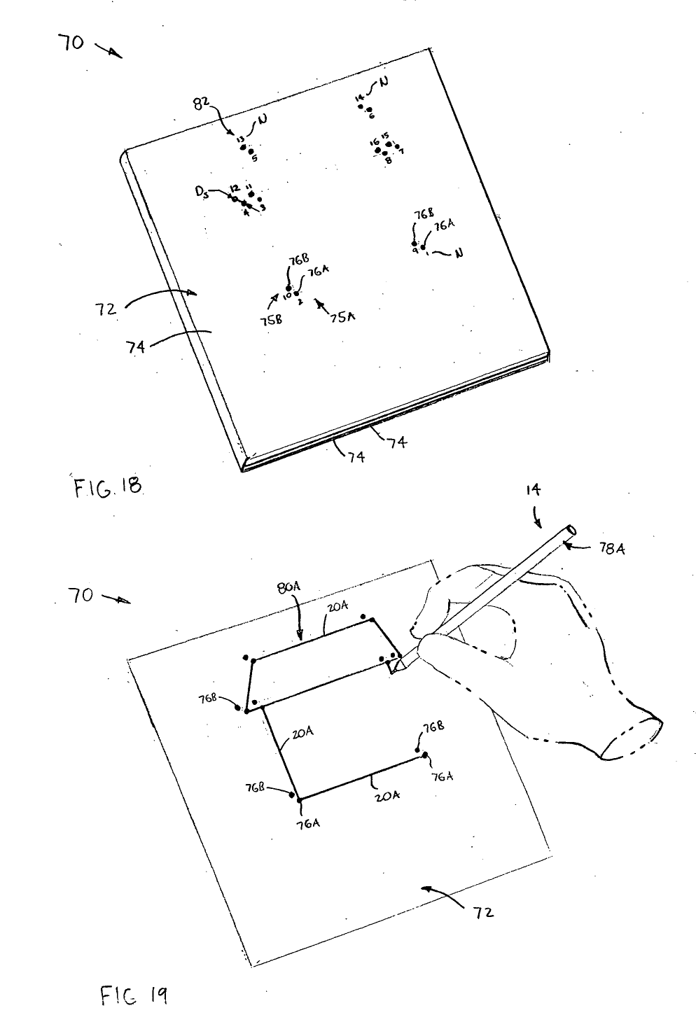

Referring now to FIGS. 18-21, an activity kit 70 of a second embodiment of the present invention includes a medium 72 with at least one and preferably a plurality of material sheets 74 each having first and second sets 75A, 75B of spaced apart marks 76A, 76B, respectively, a viewer 16 as described above, and either a drawing device 14 or two or more separate or individual drawing implements 78A, 78B. The first and second sets of marks 76A, 76B are formed on each material sheet 74 such that each mark 76A of the second set 75A is located generally proximal to and spaced apart from a separate one of the marks 76A of the first set 75A by a predetermined distance D_{S}, and vice-versa. That is, each mark 76A, 76B of each set of marks 75A, 75B is spaced apart from an associated mark 76B, 76A of the other set 75B, 75A by the same distance D_{S}. Further, the drawing device 14 is configured to form a first graphic line 20A of a first color C₁ on the medium 72, i.e., each of the one or more sheets 74, and a second graphic line 20B of a second color C₂ on the medium 74/sheet 74. As such, a single drawing device 14 may be used to simultaneously connect each adjacent pair of marks 76A of the first set 75A and each adjacent pair of marks of 76B of the second set 75B. Alternatively, the kit 70 may include a first drawing implement 78A configured to form lines of the first color C₁ and a second drawing implement 78B configured to form lines of the second color C₂.

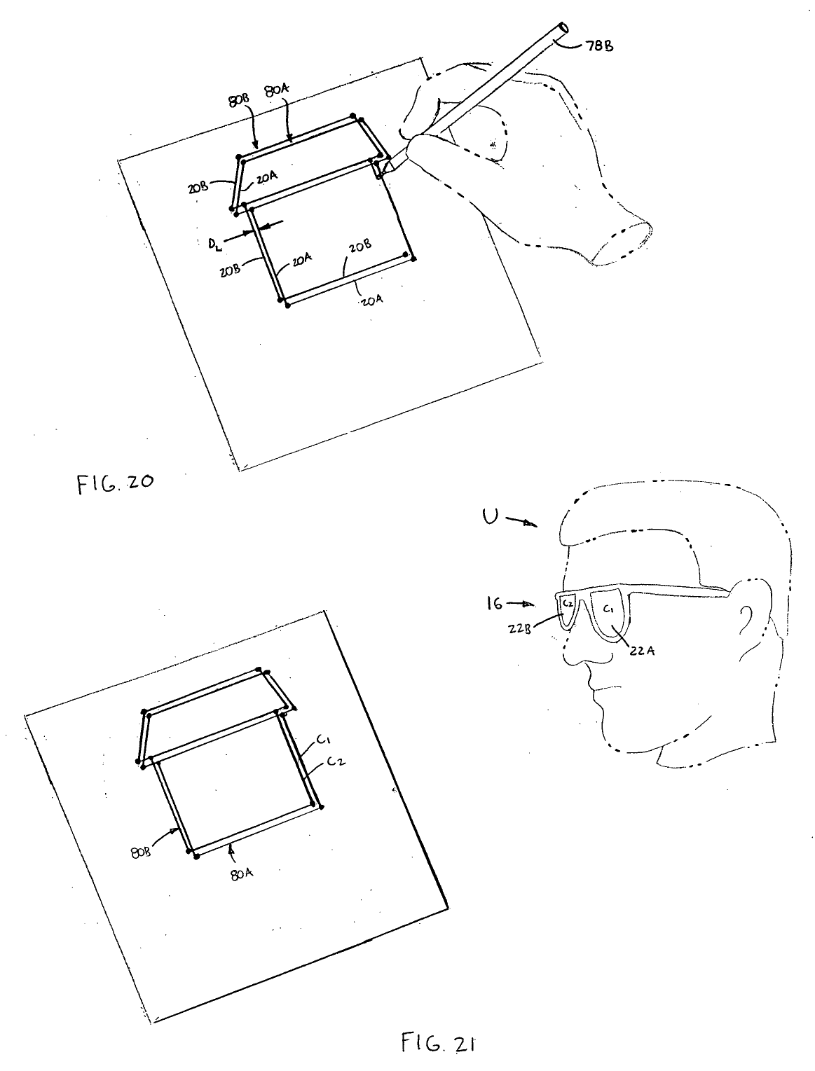

Further, the two sets 75A, 75B of marks 76A, 76B are disposed or located on the medium 72 such that when a first line 20A is drawn between each pair of generally adjacent first marks 76A, and a second line 20B is drawn between each pair of generally adjacent second marks 76B, two parallel images 80A, 80B of an object (e.g., a house, as depicted) is formed, each image 80A, 80B being of a separate color C₁, C₂. Specifically, each image 80A, 80B includes a plurality of lines 20A, 20B, respectively, and each line 20A, 20B extends parallel to, and is spaced by a distance D_{L} (FIG. 20) from, an associated line 20B, 20A. Once formed, the user U may view the images 80A, 80B through the viewer 16, and experience the lift phenomena as described above, as depicted in FIG. 21).

Additionally, the drawing kit 72 preferably further comprises printed instructions 82 (e.g., consecutive numbers, letters, symbols, etc.) on the medium 72 directing a user to draw one first line 20A between each pair of marks 76A of the first mark set 75A and to draw one second line 20B between each pair of marks 76B of the second mark set 75B. Preferably, a printed number N is preferably located adjacent to each mark 76A, 76B of each set 75A, 75B, the printed numbers N increasing incrementally such that a user is directed to draw lines 20A, 20B between the marks 76A, 76B in a specific, desired order. Thus, a user U uses either the single device 14 or the two implements 78A, 78B to connect the marks 76A, 76B in the specific sequence by following the number order, generally in the manner of a “connect the dots” drawing. Either the marks 76A, 76B of the two sets 75A, 75B of marks are simultaneously connected by a single drawing device 14, and thus each associated pair of marks 76A/76B has a single number N, or each set 75A, 75B is connected by a separate implement 78A, 78B, such that the two sets of marks 75A, 75B are separately numbered. Further, the activity kit 70 preferably includes a plurality of medium 72 provided by a book 84 (FIG. 18) having a plurality of the material sheets 74, similarly to commercially available activity books, but may alternatively be provided as one or more separate sheets 74.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined in the appended claims.

I claim:

1. An activity system for at least one of drawing and writing on a fixed medium, the system comprising:
a drawing device manually operable by a user and configured to form a first graphic line of a first color on the medium and a second graphic line of a second color on the medium such that the second line is spaced apart from and extends generally parallel with the first line; and
a viewer having a first generally transparent portion of the first color and a second generally transparent portion of the second color, the viewer being positionable generally adjacent to the user's face such that the first and second lines formed by the drawing device are viewable by the user through the two generally transparent portions.

2. The activity system as recited in claim 1 wherein the viewer is configured to be worn on the user's head such that the first transparent portion is disposed forwardly of one of the user's eyes and the second transparent portion is disposed forwardly of the other one of the user's eyes.

3. The activity system as recited in claim 1 wherein the first transparent portion is configured to filter light of the first color and the second transparent portion is configured to filter light of the second color.

4. The activity system as recited in claim 3 wherein the viewer is configured to create in the user a mental impression that the first line is disposed in a first plane and the second line is disposed in a second plane, the second plane being spaced apart from the first plane.

5. The activity system as recited in claim 1 wherein each one of the first and second transparent portions includes a generally transparent pane, each of the first and second panes being one of attached to a remainder of the viewer and integrally formed with the remainder of the viewer.

6. The activity system as recited in claim 5 wherein the viewer includes a frame mountable to the user's head and configured to retain the first and second panes such that when the frame is mounted to the user's head, the first pane is positioned generally forwardly of one of the user's eyes and the second pane is positioned generally forwardly of the other one of the user's eyes.

7. The activity kit as recited in claim 6 wherein:
each of the two panes is removably mountable to the frame;
the viewer further includes a third generally transparent pane of a third color, the third color being different than each of the first and second colors, the third pane being removably mountable to the frame when one of the first and second panes is separate from the frame; and
the drawing device is selectively configurable to form at least one third graphic line of the third color on the medium such that the third line is spaced apart from and extends generally parallel with one of one first line and one second line.

8. The activity system as recited in claim 1 wherein the drawing device is configured to simultaneously form the first and second lines.

9. The activity system as recited in claim 1 wherein the drawing device includes:
a housing;
a first reservoir disposed within the housing and containing ink of the first color;
a first applicator tip extending outwardly from the housing, fluidly connected with the first reservoir, and configured to dispense the first ink so as to form at least one first line;
a second reservoir disposed within the housing and containing ink of the second color; and
a second applicator tip extending outwardly from the housing, fluidly connected with the second reservoir, and configured to dispense the second ink so as to form at least one second line, the second tip being spaced from the first tip and the two tips being simultaneously disposeable upon the medium.

10. The activity system as recited in claim 1 wherein the drawing device includes:
a first drawing implement configured to form at least one first line and having an applicator tip;
a second drawing implement configured to form at least one second line and having an applicator tip; and
a holder configured to receive each of the first and second drawing implements and to connect the two implements such that the tip of each one of the implements is spaced apart from and located generally adjacent to the tip of the other one of the two implements.

11. The activity system as recited in claim 10 wherein each one of the first and second drawing implements is one of a pen, a magic marker, a pencil, and a highlighter.

12. The activity system as recited in claim 10 wherein the holder is configured to removably connect the two drawing implements.

13. The activity system as recited in claim 12 further comprising a third drawing implement configured to form at least one line of a third color and having an applicator tip, the holder being further configured to receive the third drawing implement when one of the first and second implements is separate from the holder and to connect the third implement with one of the first and second implements such that the applicator tip is spaced apart from and located generally adjacent to the applicator tip of the connected one of the first and second implements.

14. The activity system as recited in claim 1 wherein the drawing device is one of configured to be manually grasped by the user and configured to be attachable to one of the user's hands.

15. The activity system as recited in claim 1 wherein the drawing device includes:
a first drawing implement configured to attach to one of a user's fingers and to form the first line; and
a second drawing implement configured to attach to another one of the user's fingers and to form the second line.

16. The drawing kit as recited in claim 1 wherein the medium includes at least one of a sheet of paper, a booklet including a plurality of sheets of paper, a drawing board, and an erasable board.

17. An activity kit comprising:
a medium including at least one material sheet with a first set of spaced-apart marks and a second set of spaced-apart marks, each mark of the second set being located generally proximal to and spaced apart from a separate one of the marks of the first set by a predetermined distance; and
one of
a drawing device to form a first graphic line of a first color on the medium and a second graphic line of a second color on the medium; and
a first drawing implement configured to form lines of a first color and a second drawing implement configured to form lines of a second color.

18. The activity kit as recited in claim 16 further comprising a viewer having a first generally transparent portion of the first color and a second generally transparent portion of the second color, the viewer being positionable generally adjacent to the user's face such that the first and second lines formed by the drawing device are viewable by the user through the two generally transparent portions.

19. The activity kit as recited in claim 15 further comprising instructions directing a user to draw one first line between at least one pair of marks of the first mark set and to draw one second line between at least one pair of marks of the second mark set.

20. An activity kit for drawing images on a fixed medium, the kit comprising:
one of:
a drawing device manually operable by a user and configured to form a first graphic line of a first color on the medium and a second graphic line of a second color on the medium such that the second line is spaced apart from and extends generally parallel with the first line; and
a pair of first and second drawing implements, the first drawing implement configured to form lines of the first color and the second drawing implement configured to form lines of the second color; and
a viewer having a first generally transparent portion of the first color and a second generally transparent portion of the second color, the viewer being configured to be worn on the user's head such that first and second lines are viewable through each one of the two generally transparent portions.
